(19) United States
(12) Patent Application Publication
(10) Pub. No.: US 2026/0112737 A1
(43) Pub. Date: Apr. 23, 2026

(54) SECONDARY BATTERY FORMATION DEVICE AND SECONDARY BATTERY MANUFACTURING PROCESS

(71) Applicant: ZHEJIANG JINKO ENERGY STORAGE CO., LTD., Haining City (CN)

(72) Inventors: Yu HONG, Haining (CN); Yujun MA, Haining (CN); Zixiang YANG, Haining (CN)

(21) Appl. No.: 18/952,962

(22) Filed: Nov. 19, 2024

(30) Foreign Application Priority Data
Oct. 23, 2024 (CN) 202411488365.3

(51) Int. Cl. H01M 10/6568; H01M 10/613; H01M 10/6556; H01M 10/6563; H01M 50/636

(52) U.S. Cl. CPC H01M 10/6568; H01M 10/613; H01M 10/6556; H01M 10/6563; H01M 50/636

(57) ABSTRACT

Provided is a secondary battery formation device, including a cabinet. A formation assembly is stored at the cabinet. The formation device further includes a liquid cooling assembly arranged at the cabinet. The liquid cooling assembly includes a circulation pipeline. The circulation pipeline is configured to circulate a heat exchange medium. At least part of the circulation pipeline fits the formation assembly. The formation assembly includes a formation component, and the circulation pipeline fits the formation component. The formation component is provided with a sealing component. The sealing component has an avoid position and a block position, and the sealing component is movable between the avoid position and the block position.

### CROSS-REFERENCE TO RELATED APPLICATIONS

The present application claims priority to Chinese Application No. 202411488365.3, filed on Oct. 23, 2024, the content of which is incorporated herein by reference in its entirety.

### TECHNICAL FIELD

The present disclosure relates to the field of energy storage battery manufacturing technologies, and in particular, to a secondary battery formation device and a secondary battery manufacturing process.

### BACKGROUND

During battery manufacturing, after a cell is assembled, a series of operations such as injection, sealing, and formation are required, and finally a qualified battery is packaged.

Currently, after completion of injection and completion of standing and infiltration, the cell is required to be delivered to a formation cabinet for formation. In order to ensure quality of a solid electrolyte interface film during the formation of the cell, there are higher requirements for an ambient temperature of the formation of the cell. A formation temperature may affect viscosity and conductivity of the electrolyte and a diffusion rate of electrode material ions. Therefore, when the cell is stored in a storage cabinet, an ambient temperature of the cell needs to be adjusted.

In the related art, in order to improve accuracy of control over the ambient temperature of the cell and prevent influence with a temperature of a storage location where the formation cabinet is located, a liquid-cooling temperature control apparatus is arranged at the formation cabinet to control the ambient temperature of the cell. However, since the electrolyte is sensitive to moisture, water vapor may infiltrate into the cell during liquid-cooling temperature control, thereby affecting the quality of the battery.

### SUMMARY

A main purpose of the present disclosure is to provide a secondary battery formation device and a secondary battery manufacturing process to solve a problem of an influence on quality of a cell caused by easy entry of water vapor into the cell when a cell formation device controls a temperature by liquid cooling in the prior art.

In order to achieve the above objective, an aspect of the present disclosure provides a secondary battery formation device, including: a cabinet; a formation assembly stored at the cabinet; and a liquid cooling assembly arranged at the cabinet. The liquid cooling assembly includes a circulation pipeline, the circulation pipeline is configured to circulate a heat exchange medium, and at least part of the circulation pipeline fits the formation assembly; the formation assembly includes a formation component, and the circulation pipeline fits the formation component to adjust a temperature of the formation component; and the formation component is provided with a sealing component, the sealing component has an avoid position for avoiding the formation component and a block position for blocking the formation component, and the sealing component is movable between the avoid position and the block position, such that the formation component is in an open state or in a sealed state.

Further, the formation assembly further includes a tray, the tray is provided with a plurality of placement stations, each of the plurality of placement stations is configured to place the formation assembly, the tray is arranged at the cabinet, and the circulation pipeline fits the tray.

Further, the secondary battery formation device further includes a fan assembly arranged in the cabinet, the fan assembly includes an air outlet channel configured to blow airflow into the cabinet, the fan assembly is arranged at a top of the cabinet, and an air outlet of the air outlet channel faces a bottom surface of the cabinet.

Further, the formation component includes a liquid storage cup configured to store electrolyte, the liquid storage cup is provided with a communication channel, at least part of the sealing component is arranged in the communication channel, and the sealing component is moveable to avoid or block the communication channel.

Further, the sealing component includes: a sealing plug, at least part of the sealing plug being arranged in the communication channel; a support frame arranged in the liquid storage cup; and an elastic component arranged at the support frame. Two ends of the elastic component are connected to the support frame and the sealing plug, and the sealing plug is pushed to be inserted into the communication channel by an elastic force of the elastic component.

Further, along a direction from an inner side to an outer side of the liquid storage cup, a cross-sectional area of a flow section of the communication channel decreases, and at least part of a surface of the sealing plug fits a channel wall of the communication channel.

Further, the formation component further includes a formation cover covering the liquid storage cup, and the formation cover is detachably connected to the liquid storage cup. The secondary battery formation device further includes an ejection component arranged in the formation cover, the ejection component abuts against the sealing component and pushes the sealing component to a position where the communication channel is avoided, such that the formation cover and the liquid storage cup are in a connected state.

Further, a plurality of communication channels are provided and arranged at intervals at the liquid storage cup, a plurality of sealing components are provided and arranged in one-to-one correspondence to the plurality of communication channels, and a plurality of ejection components are provided and arranged in one-to-one correspondence to the plurality of sealing components.

Another aspect of the present disclosure provides a secondary battery manufacturing process, applied to the secondary battery formation device described above. The secondary battery manufacturing process includes: controlling the sealing component in the formation device to move to the avoid position to inject electrolyte into a cell body through the formation component in the secondary battery formation device; after the injection of the electrolyte is completed, controlling the sealing component to move to the block position to seal the formation component; charging and discharging the cell body to form a solid electrolyte interface film; subjecting the cell body to high-temperature aging after the formation of the solid electrolyte interface film; and sealing an electrolyte injection port at the cell body to obtain a battery. Herein, an ambient temperature of the cell body is controlled to 45° C.±5° C. through the liquid cooling assembly in the secondary battery formation device.

Further, after the injection of the electrolyte is completed, the cell body is subjected to high-temperature standing; and in a process of injecting the electrolyte into the cell body until the injection port is sealed, keeping the formation component mounted at the cell body, without sealing the injection port and without secondary injection of the electrolyte into the cell body. The formation component has a length of L1, a width of W1, and a height of H1; and the cell body has a length of L2, a width of W2, and a height of H2, where L1=(1 to 0.8)*L2, W1=(1 to 0.8)*W2, and H1=(1 to 0.8)*H2.

By use of the technical solutions of the present disclosure, the secondary battery formation device according to the present disclosure includes a cabinet, a formation assembly, a liquid cooling assembly, and a sealing component. The formation assembly is stored at the cabinet. The liquid cooling assembly is arranged at the cabinet. The liquid cooling assembly includes a circulation pipeline. The circulation pipeline is configured to circulate a heat exchange medium, and at least part of the circulation pipeline fits the formation assembly to adjust a temperature of a formation component. The formation assembly includes the formation component. The circulation pipeline fits the formation component. The formation component is provided with a sealing component. The sealing component has an avoid position for avoiding the formation component and a block position for blocking the formation component. The sealing component is movable between the avoid position and the block position. In this way, the temperature of the formation component can be controlled by the liquid cooling assembly. That is, the temperature of the formation component is adjusted by heat exchange of the circulation pipeline with the formation component. At the same time, in order to prevent an influence on performance of the battery caused by flowing of a liquid medium into the formation component and infiltration into the cell body, the formation component is provided with a sealing component. The sealing component has an avoid position and a block position. When the electrolyte is injected into the cell body, the sealing component moves to the avoid position. After the injection is completed, the sealing component moves to the block position. Through the arrangement of the sealing component, during formation and temperature control of the battery, sealing performance of the formation component is ensured, thereby ensuring quality of manufacturing of the battery.

### BRIEF DESCRIPTION OF DRAWINGS

The accompanying drawings forming part of the present disclosure are intended to provide further illustration of the present disclosure. Exemplary embodiments of the present disclosure and descriptions thereof are intended to explain the present disclosure, and do not constitute any inappropriate limitation on the present disclosure.

FIG. 1 is a schematic structural diagram of a cabinet in a secondary battery formation device according to the present disclosure;

FIG. 2 is a schematic structural diagram of a circulation pipeline in the secondary battery formation device according to the present disclosure;

FIG. 3 is a schematic structural diagram of a fan assembly in the secondary battery formation device according to the present disclosure;

FIG. 4 is a schematic structural diagram of a first embodiment of a sealing component in the secondary battery formation device according to the present disclosure;

FIG. 5 is a schematic structural diagram of a tray in the secondary battery formation device according to the present disclosure;

FIG. 6 is a schematic structural diagram of a second embodiment of the sealing component in the secondary battery formation device according to the present disclosure;

FIG. 7 is a schematic structural diagram of an embodiment of a liquid storage cup in the secondary battery formation device according to the present disclosure;

FIG. 8 is a flowchart of a secondary battery manufacturing process according to the present disclosure; and

FIG. 9 is a flowchart of a secondary battery manufacturing process in the prior art.

The above drawings include the following reference signs:

100: cabinet; 200: formation assembly; 300: liquid cooling assembly; 310: circulation pipeline; 210: cell body; 220: formation component; 221: liquid storage cup; 222: formation cover; 2210: communication channel; 400: sealing component; 311: temperature control branch; 230: tray; 231: placement station; 312: liquid inlet manifold; 313: first liquid inlet branch pipe; 314: second liquid inlet branch pipe; 315: avoidance space; 500: fan assembly; 510: air outlet channel; 520: air guidance channel; 521: air guidance component; 530: heat exchange channel; 531: heat exchanger; 410: sealing plug; 420: support frame; 430: elastic component; 610: magnetic conductive core; 620: electromagnetic component; 630: ejection component.

### DESCRIPTION OF EMBODIMENTS

It is to be noted that embodiments in the present disclosure and features in the embodiments may be combined with each other without conflict. The present disclosure will be described in detail below with reference to the accompanying drawings and embodiments.

As mentioned in the Background, in the prior art, when the cell is formed, the cell is placed in the formation cabinet for processing, and in order to facilitate the control over the ambient temperature of the cell, a liquid cooling apparatus is arranged at the formation cabinet to adjust the temperature of the cell body, thereby improving a formation effect. However, the liquid cooling apparatus easily produces water vapor during use, and such water vapor easily infiltrates into the cell body to affect the quality of the battery. Therefore, with respect to the above technical problem, according to a secondary battery formation device provided by the present disclosure, an ambient temperature of a cell body is adjusted through a liquid cooling assembly 300, a formation component 220 is provided with a sealing component 400, the sealing component 400 has an avoid position and a block position, and the sealing component 400 is movably arranged between the avoid position and the block position. When electrolyte is injected into the cell body, the sealing component 400 moves to the avoid position, and after the injection of the electrolyte is completed, the sealing component 400 moves to the block position. In this way, during the entire formation, the sealing component 400 does not affect the injection of the electrolyte, and the sealing component 400 can also be used to maintain sealing of the formation component 220 to prevent entry of water vapor produced by a heat exchange medium into the cell body through the formation component 220, thereby ensuring sealing performance of the cell body during the entire formation and ensuring quality of the battery.

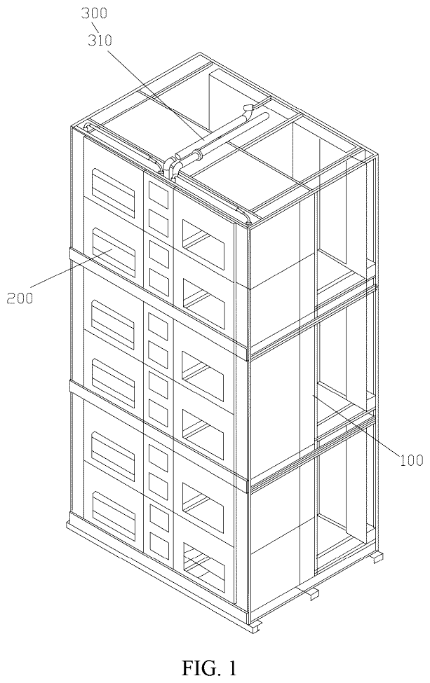

Referring to FIG. 1 to FIG. 7, the present disclosure provides a secondary battery formation device, including a cabinet 100. A formation assembly 200 is stored at the cabinet 100. The formation device further includes: a liquid cooling assembly 300 arranged at the cabinet 100. The liquid cooling assembly 300 includes a circulation pipeline 310. The circulation pipeline 310 is configured to circulate a heat exchange medium. At least part of the circulation pipeline 310 fits/abuts against the formation assembly 200 to adjust a temperature of a formation component 220. The formation assembly 200 includes the formation component 220. The circulation pipeline 310 fits the formation component 220. The formation component 220 is provided with a sealing component 400. The sealing component 400 has an avoid position and a block position. The sealing component 400 is movably arranged between the avoid position and the block position, so that the formation component 220 is in an open state or a sealed state.

A secondary battery formation device according to the present disclosure includes a cabinet 100, a formation assembly 200, a liquid cooling assembly 300, and a sealing component 400. The formation assembly 200 is stored at the cabinet 100. The liquid cooling assembly 300 is arranged at the cabinet 100. The liquid cooling assembly 300 includes a circulation pipeline 310. The circulation pipeline 310 is configured to circulate a heat exchange medium. At least part of the circulation pipeline 310 fits the formation assembly 200. The formation assembly 200 includes a formation component 220. The circulation pipeline 310 fits the formation component 220 to adjust a temperature of the formation component 220. The formation component 220 is provided with a sealing component 400. The sealing component 400 has an avoid position and a block position. The sealing component 400 is movably arranged between the avoid position and the block position, so that the formation component 220 is in an open state or a sealed state. In this way, the temperature of the formation component 220 can be controlled by the liquid cooling assembly 300. That is, the temperature of the formation component 220 is adjusted by heat exchange of the circulation pipeline 310 with the formation component 220. At the same time, in order to prevent an influence on performance of the battery caused by flowing of a liquid medium into the formation component 220 and infiltration into the cell body, the formation component 220 is provided with a sealing component 400. The sealing component 400 has an avoid position and a block position. When injecting the electrolyte into the cell body, the sealing component 400 moves to the avoid position. After the injection is completed, the sealing component 400 moves to the block position. Through the arrangement of such a sealing component 400, during formation and temperature control of the battery, sealing performance of the formation component 220 is ensured, thereby ensuring the quality of manufacturing of the battery.

In an example, in order to improve accuracy of temperature control over the liquid cooling assembly 300, the circulation pipeline 310 is arranged around the formation component 220, or, the circulation pipeline 310 includes a plurality of temperature adjustment branches 311. Each temperature adjustment branch 311 fits a bottom surface or a side surface of the formation component 220. The circulation pipeline 310 is arranged around the formation component 220, or each temperature adjustment branch 311 fits the bottom surface or the side surface of the formation component 220, so that the temperature of the forming part 220 is evenly distributed, thereby improving the formation effect of the cell body.

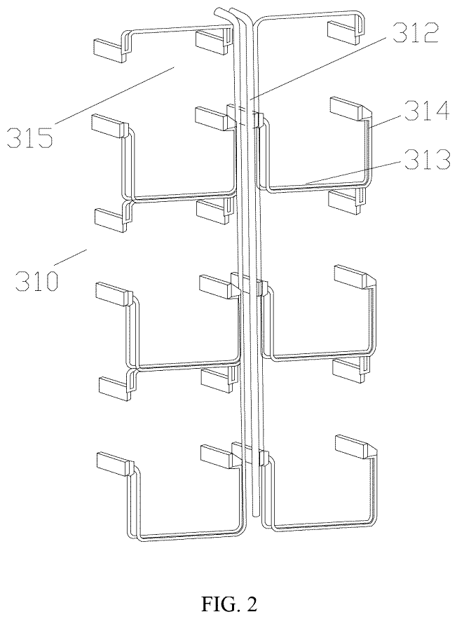

During implementation, as shown in FIG. 2, the circulation pipeline 310 includes: a liquid inlet manifold 312 extending along a length direction of the cabinet 100; a first liquid inlet branch 313 in communication with the liquid inlet manifold 312 and extending along a width direction of the cabinet 100, the first liquid inlet branch 313 fitting a first side surface of the formation component 220; and a second liquid inlet branch 314 in communication with the first liquid inlet branch 313 and extending along a height direction of the cabinet 100, the second liquid inlet branch 314 fitting a second side surface of the formation component 220. One first liquid inlet branch 313 is in communication with at least two second liquid inlet branches 314. An avoidance space 315 configured to avoid the formation assembly 200 is arranged between each second liquid inlet branch 314 and the first liquid inlet branch 313. In this way, after the formation component 220 is placed in the cabinet 100, temperatures of the first side surface and the second side surface of the formation component 220 are controlled. Through the arrangement of the at least two second liquid inlet branches 314, the two second liquid inlet branches 314 can fit two formation components 220 in two formation assemblies 200.

In order to prevent generation of condensed water on the circulation pipeline 310, the circulation pipeline 310 is covered with an insulation layer. The circulation pipeline 310 is provided with a pressure detection component configured to detect sealing performance inside the circulation pipeline 310.

In an example, the formation assembly 200 further includes: a tray 230, the tray 230 is provided with a plurality of placement stations 231, each placement station 231 is configured to place the formation component 220, the tray 230 is arranged at the cabinet 100, and the circulation pipeline 310 fits the tray 230. During implementation, for example, each tray 230 is provided with a plurality of formation components 220, a plurality of trays 230 are placed at the cabinet 100 to process the cell, and the circulation pipeline 310 directly fits the tray 230, so as to control temperatures of the plurality of formation components 220 on the tray 230. The first liquid inlet branch 313 and the second liquid inlet branch 314 fit the tray 230, respectively.

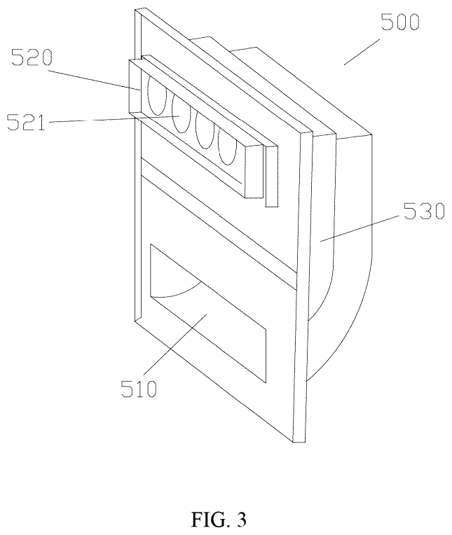

In the embodiments provided in the present disclosure, as shown in FIG. 3, the formation device further includes: a fan assembly 500 arranged in the cabinet 100, the fan assembly 500 includes an air outlet channel 510, and the air outlet channel 510 is configured to blow airflow into the cabinet 100. The fan assembly 500 is arranged at a top of the cabinet 100, and an air outlet of the air outlet channel 510 faces a bottom surface of the cabinet 100. The fan assembly 500 combined with the liquid cooling assembly 300 makes the temperature distribution in the entire cabinet 100 more uniform. After the liquid cooling assembly 300 operates, generated cold/hot air is circulated throughout the cabinet 100 by using the fan assembly 500. The fan assembly 500 is preferably arranged at the top of the cabinet 100, with the air outlet of the air outlet channel 510 facing the bottom surface of the cabinet 100, so as to realize air supply in the cabinet 100 from top to bottom.

Further, the fan assembly 500 further includes: an air guidance channel 520, and the air guidance channel 520 is provided with an air guidance component 521, for introducing airflow in the cabinet 100 into the air guidance channel 520; and a heat exchange channel 530 provided with a heat exchanger 531, two ends of the heat exchange channel 530 being in communication with the air guidance channel 520 and the air outlet channel 510, respectively. In this way, the airflow in the cabinet 100 is drawn into the heat exchange channel 530 by using the air guidance channel 520 for heat exchange and then blown out through the air outlet channel 510, thereby further ensuring that the ambient temperature in the cabinet 100 is always maintained within a preset temperature range. Moreover, under an action of the airflow, the water vapor generated by the liquid cooling assembly 300 can be quickly evaporated, thereby reducing humidity in the cabinet 100. The heat exchange channel 530 is provided therein with a heat exchanger 531. After the airflow in the air guidance channel 520 is heat exchanged by the heat exchanger 531, the temperature decreases, and the cold air flows from bottom to top, taking away heat of the formation assembly 200, and is then introduced into the air guidance channel 520 to complete a complete cycle/circulation.

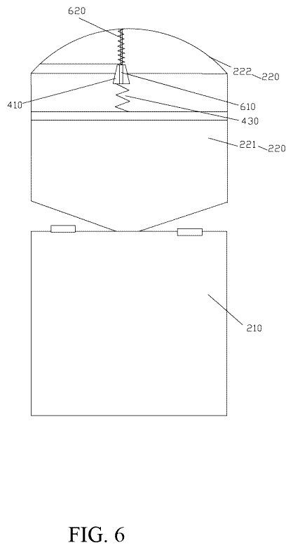

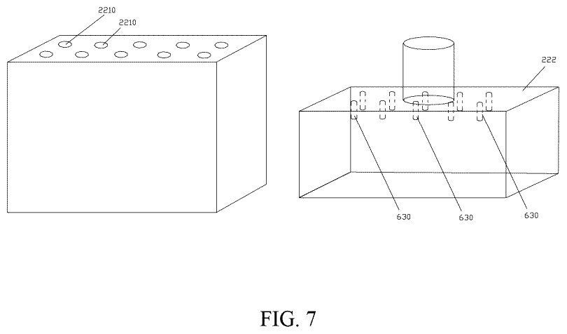

During implementation, as shown in FIG. 6, the formation component 220 includes: a liquid storage cup 221 configured to store electrolyte, the liquid storage cup 221 is provided with a communication channel 2210, at least part of the sealing component 400 is arranged in the communication channel 2210, and the sealing component 400 is movably arranged to avoid or block the communication channel 2210. When the sealing component 400 is at the avoid position, the electrolyte is injected into the cell body through the communication channel 2210. After the injection is completed, the sealing component 400 blocks the communication channel 2210, so that the sealing component 400 is at the block position, to ensure sealing performance of the liquid storage cup 221.

The sealing component 400 includes: a sealing plug 410, at least part of the sealing plug 410 being arranged in the communication channel 2210; a support frame 420 arranged in the liquid storage cup 221; and an elastic component 430 arranged at the support frame 420, two ends of the elastic component 430 being connected to the support frame 420 and the sealing plug 410, and the sealing plug 410 being pushed to be inserted into the communication channel 2210 by an elastic force of the elastic component 430. Through the arrangement of the elastic component 430, under an action of an elastic restoring force of the elastic component 430, the sealing plug 410 is pushed to remain in the communication channel 2210 to be in a blocked state, thereby preventing entry of the water vapor into the cell from the communication channel 2210.

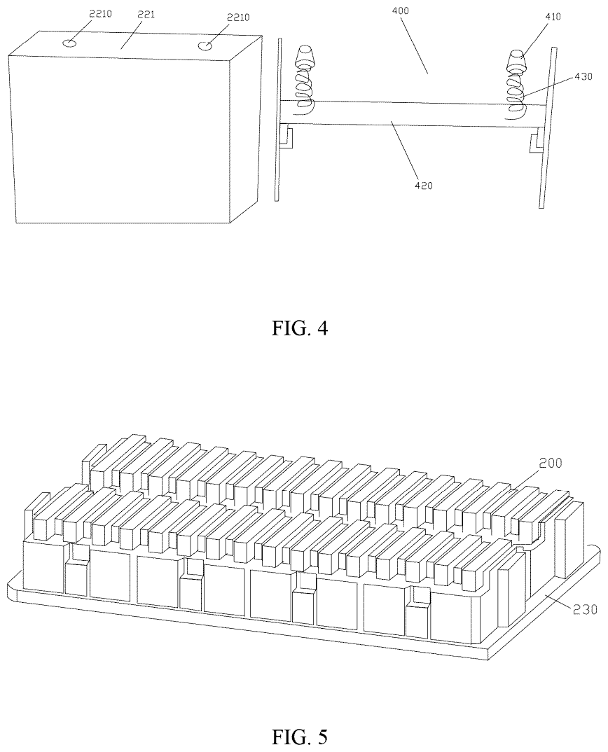

In an embodiment of the present disclosure, as shown in FIG. 4, at least two communication channels 2210 are provided, each communication channel 2210 is correspondingly provided with a respective sealing plug 410, the elastic components 430 are arranged in one-to-one correspondence to the sealing plugs 410, and each elastic component 431 is arranged on the support frame 420 for mounting. The elastic component 430 is, for example, a spring.

In an example, in a direction from an inner side to an outer side of the liquid storage cup 221, a cross-sectional area of a flow section of the communication channel 2210 gradually decreases, and at least part of a surface of the sealing plug 410 fits a channel wall of the communication channel 2210. In this way, during movement of the sealing plug 410 from the avoid position to the block position, the sealing plug 410 can be guided to some extent by using a change in the cross-sectional area of the flow section of the communication channel 2210, and at the same time, it can be ensured that the sealing plug 410 can completely block the communication channel 2210.

In an example, at least part of the channel wall of the communication channel 2210 is a tapered surface, and at least part of the surface of the sealing plug 410 fits the channel wall. For example, the channel wall of the communication channel 2210 is a tapered surface, and the sealing plug 410 has a conical structure or a truncated cone structure. In this way, during the movement of the sealing plug 410, the sealing plug 410 can be guided by using the tapered surface.

During implementation, the formation component 220 further includes a formation cover 222 covering the liquid storage cup 221, the formation cover 222 is detachably connected to the liquid storage cup 221, and the formation device further includes: an ejection component 630 arranged in the formation cover 222. The ejection component 630 abuts against the sealing component 400 and pushes the sealing component 400 to a position where the communication channel 2210 is avoided, so that the formation cover 222 and the liquid storage cup 221 are in a connected state. When injecting the electrolyte, the formation cover 222 is placed on the liquid storage cup 221. In this case, the ejection component 630 is in contact with the sealing plug 410 and pushes the sealing plug 410 to move downwards against the elastic force of the elastic component 430 to create a gap between the sealing plug 410 and the communication channel 2210, and the electrolyte flows into the liquid storage cup 221 from the gap to complete the injection. After the injection is completed, the formation cover 222 is removed. In this case, the ejection component 630 is separated from the sealing plug 410, and the sealing plug 410 is subjected only to a force of the elastic component 430 to gradually move to the block position.

In this embodiment, the formation device further includes a magnetic conductive core 610 arranged in the sealing plug 410; an electromagnetic component 620 arranged in the formation cover 222 and located above the magnetic conductive core 610. By energizing the electromagnetic component 620, a magnetic force generated by the electromagnetic component 620 pushes the magnetic conductive core 610, and the magnetic conductive core 610 drives the sealing plug 410 to move to avoid the communication channel 2210. Through the arrangement of the magnetic conductive core 610 in the sealing plug 410, when the electromagnetic component 620 is energized, a magnetic force is generated, thereby pushing the magnetic conductive core 610 to drive the sealing plug 410 to move downwards. An end of the magnetic conductive core 610 opposite to the electromagnetic component 620 is located in a same plane as an end face of the sealing plug 410, or an end of the magnetic conductive core 610 opposite to the electromagnetic component 620 protrudes from an end face of the sealing plug 410, to ensure that an electromagnetic force generated by the electromagnetic component 620 can be applied to the magnetic conductive core 610.

In another embodiment provided in the present disclosure, a plurality of communication channels 2210 are provided and arranged at intervals at the liquid storage cup 221, a plurality of sealing components 400 are provided and arranged in one-to-one correspondence to the plurality of communication channels 2210, and a plurality of ejection components 630 are provided and arranged in one-to-one correspondence to the plurality of sealing components 400. In this embodiment, each ejection component 630 is telescopically arranged along a vertical direction, and each ejection component 630 is controlled separately. Each ejection component 630 is arranged in the formation cover 222. During the injection, only one or more required communication channels 2210 are opened. When gas is generated during the formation, each ejection component 630 may be controlled to push each sealing component 400 to the avoid position, thereby achieving rapid exhaust.

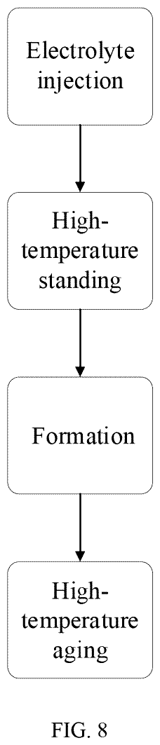

The present disclosure further provides a secondary battery manufacturing process, which, as shown in FIG. 8, is applied to the secondary battery formation device in the above embodiments. The secondary battery manufacturing process includes: controlling the sealing component 400 in the formation device to move to the avoid position, to inject electrolyte into a cell body 210 through the formation component 220 in the formation device; after the injection of the electrolyte is completed, controlling the sealing component 400 to move to the block position to seal the formation component 220; charging and discharging the cell body 210 to form a solid electrolyte interface film; subjecting the cell body 210 to high-temperature aging after the formation of the solid electrolyte interface film; and sealing an electrolyte injection port at the cell body 210 to obtain a battery. An ambient temperature of the cell body 210 is controlled to 45° C.±5° C. through the liquid cooling assembly 300 in the formation device. In this way, a temperature in the step of subjecting the cell body 210 to high-temperature aging is 45° C.±5° C., and a temperature of the cell body 210 itself is 40° C. to 60° C.

After the injection of the electrolyte is completed, the cell body is subjected to standing. In a process of injecting the electrolyte into the cell body 210 until the injection port is sealed, the formation component 220 is mounted at the cell body, without sealing the injection port and without secondary injection of the electrolyte into the cell body. The formation component 220 has a length of L1, a width of W1, and a height of H1. The cell body 210 has a length of L2, a width of W2, and a height of H2. In an embodiment, L1=(1 to 0.8)*L2; W1=(1 to 0.8)*W2; and H1=(1 to 0.8)*H2.

In an embodiment, the secondary battery manufacturing process includes the following steps.

The sealing component 400 in the formation device is controlled to move to the avoid position, to inject electrolyte into a cell body 210 through the formation component 220 in the formation device.

The liquid storage cup 221 is placed at the cell body. When the formation cover 222 covers the liquid storage cup 221, the ejection component 630 in the formation cover 222 pushes the sealing plug 410 downwards, so that the sealing plug 410 avoids the communication channel 2210, thereby injecting the electrolyte into the cell body for the first time.

After the injection of the electrolyte is completed, the sealing component 400 is controlled to move to the block position to seal the formation component 220.

After the injection of the electrolyte is completed, the formation cover 222 is moved away, and under an action of the elastic component 430, the sealing plug 410 is pushed back to the position where the communication channel 2210 is blocked. In this state, the cell body and the liquid storage cup 221 are an entirety, and the sealed state of the cell body is maintained by using the sealing plug 410.

The cell body 210 is charged and discharged to form a solid electrolyte interface film.

Formation is the first charging process of the battery, which is used to activate active materials in the battery and form a solid electrolyte interface film on a negative electrode side. In this process, the liquid storage cup 221 is maintained in a sealed state by using the sealing plug 410, to prevent an influence on quality of the battery caused by entry of the water vapor generated by the liquid cooling assembly 200 into the cell body.

The cell body 210 is subjected to high-temperature aging after the formation of the solid electrolyte interface film.

In this step, it is ensured that the electrolyte can fully infiltrate an electrode sheet, which is conducive to stability of performance of the battery. An ambient temperature of the cell body and the temperature of the cell body are controlled by using the liquid cooling assembly 200.

Then, an electrolyte injection port at the cell body 210 is sealed to obtain a battery.

During an actual operation, when the electrolyte is injected for the first time, an amount of the electrolyte is calculated. After the first injection is completed, the liquid storage cup 221 is not detached from the cell body, and it is directly subjected to high-temperature infiltration, formation, and aging. Since gas may be generated inside the cell body during the formation, the formation cover 222 covers the liquid storage cup 221, and the sealing plug 410 is pushed away, to allow the liquid storage cup 221 to be communicated with negative pressure and discharge the gas. If the liquid cooling assembly 300 is abnormal in this process, the formation cover 222 may be directly removed to restore the sealing.

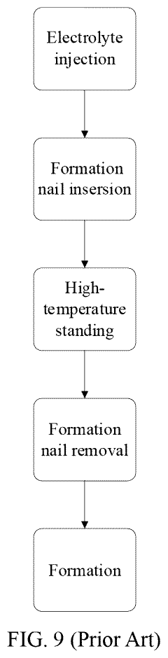

In the prior art, as shown in FIG. 9, the following process is mainly included. The electrolyte is injected for the first time, a formation nail is then injected into the injection port of the cell body, and the battery is required to be sealed to prevent leakage of the electrolyte and external contamination. Standing is carried out prior to formation, to ensure that the electrolyte fully infiltrates positive and negative electrode materials and a separator of the battery. The formation nail is removed to ensure that gas generated inside the battery can be discharged smoothly during the formation. Formation is carried out to activate the active materials in the battery and form a solid electrolyte interface film on the negative electrode side. Then, the formation nail is continuously inserted into the injection port of the cell body for standing after sealing. If secondary injection is required, the formation nail is removed and the cell is placed into an electrolyte injection device for secondary injection. The cell body is required to be weighed to calculate an amount of the electrolyte for secondary injection. After secondary injection is completed, the injection port is sealed to ensure sealing and safety of the battery.

In the formation process in the prior art, that is, after the first injection is completed, the formation nail is inserted into the injection port of the cell body, standing is then carried out prior to formation, the formation nail is pulled out, the cell body is formed, and after the formation, the formation nail is inserted into the injection port and subjected to standing. Compared with the formation process in the prior art described above, by use of the formation device in the present disclosure, the steps of inserting the formation nail and pulling out the formation nail are eliminated, and the liquid storage cup 221 can be used directly for secondary injection, and sealing and gas exhaust can be achieved by directly using the liquid storage cup 221 and the sealing component 400.

In the present disclosure, prior to the formation, the electrolyte injection is carried performed at a formation cup with an upper sealing structure, and an entire formation tray is connected to an entire cell. After standing, it is sent to the corresponding formation cabinet for formation. After standing, it is subjected to secondary injection or no secondary injection (first injection has been completed), and after completion, tray separation is directly completed. Standing at the entire formation and before and after the formation adopts water-cooling temperature control without humidity control. After the change, the process flow is simplified, and a plug-in mechanism can be eliminated. By use of water cooling temperature control, overall tray control instead of workshop environment control is achieved, which is more energy-saving. By calculating the amount of electrolyte, the first electrolyte injection and the second electrolyte injection can be combined to further streamline the process, thereby achieving ultimate manufacturing.

As can be seen from the above description, the embodiments of the present disclosure achieve the following technical effects.

The formation device according to the present disclosure includes a cabinet 100, a formation assembly 200, a liquid cooling assembly 300, and a sealing component 400. The formation assembly 200 is stored at the cabinet 100. The liquid cooling assembly 300 is arranged at the cabinet 100. The liquid cooling assembly 300 includes a circulation pipeline 310. The circulation pipeline 310 is configured to circulate a heat exchange medium. At least part of the circulation pipeline 310 fits the formation assembly 200. The formation assembly 200 includes a formation component 220. The circulation pipeline 310 fits the formation component 220 to adjust a temperature of the formation component 220. The formation component 220 is provided with a sealing component 400. The sealing component 400 has an avoid position and a block position. The sealing component 400 is movably arranged between the avoid position and the block position, so that the formation component 220 is in an open state or a sealed state. In this way, the temperature of the formation component 220 can be controlled by the liquid cooling assembly 300. That is, the temperature of the formation component 220 is adjusted by heat exchange of the circulation pipeline 310 with the formation component 220. At the same time, in order to prevent an influence on performance of the battery caused by flowing of a liquid medium into the formation component 220 and infiltration into the cell body, the formation component 220 is provided with a sealing component 400. The sealing component 400 has an avoid position and a block position. When injecting the electrolyte into the cell body, the sealing component 400 moves to the avoid position. After the injection is completed, the sealing component 400 moves to the block position. Through the arrangement of the sealing component 400, during formation and temperature control of the battery, sealing performance of the formation component 220 is ensured, thereby ensuring quality of manufacturing of the battery.

The above are merely some embodiments of the present disclosure and are not intended to limit the present disclosure. For those skilled in the art, various modifications and changes may be made to the present disclosure. Any modifications, equivalent replacements, improvements, and the like made within the spirit and principles of the present disclosure shall be included in the scope of the claims of the present disclosure.

What is claimed is:

1. A secondary battery formation device, comprising:
a cabinet (100);
a formation assembly (200) stored at the cabinet (100); and
a liquid cooling assembly (300) arranged at the cabinet (100),
wherein the liquid cooling assembly (300) comprises a circulation pipeline (310), the circulation pipeline (310) is configured to circulate a heat exchange medium, and at least part of the circulation pipeline (310) fits the formation assembly (200);
wherein the formation assembly (200) comprises a formation component (220), and the circulation pipeline (310) fits the formation component (220) to adjust a temperature of the formation component (220); and
wherein the formation component (220) is provided with a sealing component (400), the sealing component (400) has an avoid position for avoiding the formation component (220) and a block position for blocking the formation component (220), and the sealing component (400) is movable between the avoid position and the block position, such that the formation component (220) is in an open state or in a sealed state.

2. The secondary battery formation device according to claim 1, wherein the circulation pipeline (310) is arranged around the formation component (220).

3. The secondary battery formation device according to claim 1, wherein the circulation pipeline (310) comprises a plurality of temperature adjustment branches (311), each of which fits a bottom surface or a side surface of the formation component (220).

4. The secondary battery formation device according to claim 1, wherein the circulation pipeline (310) comprises: a liquid inlet manifold (312) extending along a length direction of the cabinet (100); a first liquid inlet branch (313) in communication with the liquid inlet manifold (312) and extending along a width direction of the cabinet (100), the first liquid inlet branch (313) fitting a first side surface of the formation component (220); and a second liquid inlet branch (314) in communication with the first liquid inlet branch (313) and extending along a height direction of the cabinet (100), the second liquid inlet branch (314) fitting a second side surface of the formation component (220).

5. The secondary battery formation device according to claim 4, wherein one first liquid inlet branch (313) is in communication with at least two second liquid inlet branches (314), and an avoidance space (315) configured to avoid the formation assembly (200) is arranged between each second liquid inlet branch (314) and the first liquid inlet branch (313).

6. The secondary battery formation device according to claim 1, wherein the circulation pipeline (310) is covered with an insulation layer.

7. The secondary battery formation device according to claim 1, wherein the circulation pipeline (310) is provided with a pressure detection component configured to detect sealing performance inside the circulation pipeline (310).

8. The secondary battery formation device according to claim 1, wherein the formation assembly (200) further comprises a tray (230), the tray (230) is provided with a plurality of placement stations (231), each of the plurality of placement stations (231) is configured to place the formation assembly (200), the tray (230) is arranged at the cabinet (100), and the circulation pipeline (310) fits the tray (230).

9. The secondary battery formation device according to claim 1, further comprising a fan assembly (500) arranged in the cabinet (100), wherein the fan assembly (500) comprises an air outlet channel (510) configured to blow airflow into the cabinet (100), the fan assembly (500) is arranged at a top of the cabinet (100), and an air outlet of the air outlet channel (510) faces a bottom surface of the cabinet (100).

10. The secondary battery formation device according to claim 9, wherein the fan assembly (500) further comprises: an air guidance channel (520), the air guidance channel (520) being provided with an air guidance component (521) for introducing airflow in the cabinet (100) into the air guidance channel 520; and a heat exchange channel (530) provided with a heat exchanger (531), two ends of the heat exchange channel (530) being in communication with the air guidance channel (520) and the air outlet channel (510), respectively.

11. The secondary battery formation device according to claim 1, wherein the formation component (220) comprises a liquid storage cup (221) configured to store electrolyte, the liquid storage cup (221) is provided with a communication channel (2210), at least part of the sealing component (400) is arranged in the communication channel (2210), when a gap is provided between the sealing component (400) and the communication channel (2210), the sealing component (400) is at the avoid position, and when the sealing component (400) blocks the communication channel (2210), the sealing component (400) is at the block position.

12. The secondary battery formation device according to claim 11, wherein the sealing component (400) comprises:
a sealing plug (410), wherein at least part of the sealing plug (410) is arranged in the communication channel (2210);
a support frame (420) arranged in the liquid storage cup (221); and
an elastic component (430) arranged at the support frame (420), wherein two ends of the elastic component (430) are connected to the support frame (420) and the sealing plug (410), and the sealing plug (410) is pushed to be inserted into the communication channel (2210) by an elastic force of the elastic component (430).

13. The secondary battery formation device according to claim 12, wherein at least two communication channels (2210) are provided, each communication channel (2210) is correspondingly provided with a respective sealing plug (410), the elastic components (430) are arranged in one-to-one correspondence to the sealing plugs (410), and each elastic component (431) is arranged on the support frame 420 for mounting.

14. The secondary battery formation device according to claim 12, wherein the elastic component (430) a spring.

15. The secondary battery formation device according to claim 12, wherein along a direction from an inner side to an outer side of the liquid storage cup (221), a cross-sectional area of a flow section of the communication channel (2210) decreases, and at least part of a surface of the sealing plug (410) fits a channel wall of the communication channel (2210).

16. The secondary battery formation device according to claim 15, wherein at least part of the channel wall of the communication channel (2210) is a tapered surface, and at least part of the surface of the sealing plug (410) fits the channel wall.

17. The secondary battery formation device according to claim 15, wherein the channel wall of the communication channel (2210) is a tapered surface, and the sealing plug (410) has a conical structure or a truncated cone structure.

18. The secondary battery formation device according to claim 11,
wherein the formation component (220) further comprises a formation cover (222) covering the liquid storage cup (221), and the formation cover (222) is detachably connected to the liquid storage cup (221); and
wherein the secondary battery formation device further comprises an ejection component (630) arranged in the formation cover (222), the ejection component (630) abuts against the sealing component (400) and pushes the sealing component (400) to a position where the communication channel (2210) is avoided, such that the formation cover (222) and the liquid storage cup (221) are in a connected state.

19. The secondary battery formation device according to claim 18, wherein a plurality of communication channels (2210) are provided and arranged at intervals at the liquid storage cup (221), a plurality of sealing components (400) are provided and arranged in one-to-one correspondence to the plurality of communication channels (2210), and a plurality of ejection components (630) are provided and arranged in one-to-one correspondence to the plurality of sealing components (400).

20. The secondary battery formation device according to claim 1, wherein the formation component (220) has a length of L1, a width of W1, and a height of H1; and a cell body on which (210) the formation component (220) performs formation has a length of L2, a width of W2, and a height of H2, where L1=(1 to 0.8)*L2, W1=(1 to 0.8)*W2, and H1=(1 to 0.8)*H2.
